(19) United States
(12) Patent Application Publication
(10) Pub. No.: US 2026/0095080 A1
(43) Pub. Date: Apr. 2, 2026

(54) COIL FEEDING APPARATUS FOR MANUFACTURE OF HAIRPIN FOR MOTOR OF ELECTRIC VEHICLE

(71) Applicants: Hyundai Motor Company, Seoul (KR); Kia Corporation, Seoul (KR); Pyeong Hwa Technology Co., Ltd., Changwon (KR); Hyundai Mobis Co., Ltd., Seoul (KR)

(72) Inventors: Won Il Kim, Hwaseong (KR); Chanui Park, Hwaseong (KR); Kyoung Min Park, Hwaseong (KR); Seungwon Song, Hwaseong (KR); Kyung Seok Yoo, Changwon (KR); Taek Soo Yang, Changwon (KR); Yong Seok Lim, Changwon (KR); Min Soo Kang, Seoul (KR)

(21) Appl. No.: 19/037,971

(22) Filed: Jan. 27, 2025

(30) Foreign Application Priority Data
Sep. 27, 2024 (KR) 10-2024-0131744

(51) Int. Cl. H02K 15/0643; H02K 15/40

(52) U.S. Cl. CPC H02K 15/0643; H02K 15/40; H02K 2215/00

(57) ABSTRACT

A coil feeding apparatus is configured to feed a material coil in a predetermined direction to manufacture a hairpin of a motor. The coil feeding apparatus includes a base plate provided on an upper surface thereof with a base rail and a guide rail connected to each other to form a straight path, a feeding module provided so as to reciprocate along the base rail and provided with a plurality of feeding grippers configured to grip the material coil, a fixed module disposed downstream of the feeding module on a feeding path of the material coil while being spaced a predetermined distance from the feeding module and provided with a fixed gripper configured to grip the material coil, and a guide module disposed between the feeding module and the fixed module to guide the material coil so that the material coil is fed straight.

### CROSS-REFERENCE TO RELATED APPLICATION

The present application claims under 35 U.S.C. § 119(a) the benefit of Korean Patent Application No. 10-2024-0131744 filed on Sep. 27, 2024, the entire contents of which are incorporated herein by reference.

### BACKGROUND

### (a) Technical Field

The present disclosure relates to a coil feeding apparatus for manufacture of a hairpin for a motor of an electric vehicle, more particularly, to the coil feeding apparatus configured to feed a linear material coil in units of a feed pitch, which is a length of the material coil required for manufacture of each hairpin of the motor.

### (b) Description of the Related Art

Electric vehicles are driven by motors. A motor produces kinetic energy using electric energy. Most motors include a stator and a rotor. The stator is wound with a highly conductive copper wire. When current flows through the copper wire, a certain magnetic field is formed around the stator. The rotor may be a steel core and/or a magnet. The rotor rotates under the influence of the magnetic field generated around the stator. The motor converts the electric energy supplied to the stator into kinetic energy for rotation of the rotor relative to the stator.

As the density per unit volume of the copper wire wound on the stator increases, the efficiency and performance of the motor may be improved. Therefore, a copper wire having a rectangular cross-section may be used in order to more densely wind the copper wire on the stator.

In addition, in order to improve the performance and efficiency of the motor, a hairpin-type stator, which is manufactured by transforming a copper wire, cut to a predetermined length, into a hairpin form and then mounting the hairpin in a stator slot, is widely used for manufacture of the motor.

The hairpin is manufactured by processing a linear copper coil having a rectangular cross-section.

The copper coil used for manufacture of the hairpin has a thin insulating film coated on an outer surface thereof. The insulating film is made of an insulative material such as enamel.

A plurality of hairpins is mounted in stator slots. The hairpins arranged in the stator slots in a predetermined pattern form the stator.

The insulating film is coated on the surface of the hairpin in order to prevent electrical short circuit between adjacent hairpins. Portions of the insulating film coated on two ends of the hairpin are removed to expose the copper wire in order to achieve electrical connection to a circuit.

Conventionally, in most cases, a bending process is performed on a predetermined portion of a copper wire that is fed in real time in the longitudinal direction thereof immediately after being unwound from a winding bobbin, and a stripping apparatus and a cutting apparatus are sequentially disposed.

However, as a difference between times required for the respective processes increases, the overall hairpin production time increases, and productivity deteriorates.

### SUMMARY

An aspect of the present disclosure is directed to a motor for an electric vehicle, in particular, to solving a problem with the related art that, while a copper wire is fed, a portion of the copper wire sags or is deformed by external force applied to the copper wire.

Another aspect of the present disclosure is directed to solving a problem with the related art that a speed at which a copper wire is fed or a length by which the copper wire is fed per unit time is not capable of being adjusted for each processing process, and thus productivity is low.

The aspects of the present disclosure are not limited to those mentioned above, and other aspects or objects not mentioned herein will be clearly understood by those skilled in the art from the following description.

In one aspect, a coil feeding apparatus configured to feed a material coil to manufacture a hairpin for a motor may include: a base plate provided on an upper surface with a base rail and a guide rail, the base rail and the guide rail being connected to each other to form a straight path; a feeding module configured to grip an outer periphery of the material coil; a fixed module along a feeding path of the material coil, the fixed module being configured to grip the material coil; and a guide module disposed between the feeding module and the fixed module, configured to guide the material coil.

In certain preferred systems, the feeding module may be configured to reciprocate along the base rail.

In certain preferred embodiments, the fixed module is positioned downstream of the feeding module.

In an aspect, a coil feeding apparatus for manufacture of a hairpin according to an embodiment of the present disclosure is an apparatus configured to feed a material coil (e.g., by a predetermined length in a predetermined direction), and includes a base plate provided on an upper surface thereof with a base rail and a guide rail connected to each other to form a straight path, a feeding module provided so as to reciprocate along the base rail, the feeding module being provided with a plurality of feeding grippers configured to grip the material coil, a fixed module disposed downstream of the feeding module on a feeding path of the material coil and spaced a predetermined distance from the feeding module, the fixed module being provided with a fixed gripper configured to grip the material coil, and a guide module disposed between the feeding module and the fixed module to guide the material coil so that the material coil is fed straight.

In the coil feeding apparatus for manufacture of a hairpin according to the embodiment of the present disclosure, the feeding module may include a feeding plate coupled to the base rail so as to move along the base rail, a grip box provided on the feeding plate, the grip box having a space defined therein to allow the material coil to pass therethrough in a longitudinal direction of the material coil, a plurality of feeding grippers provided in the grip box, the plurality of feeding grippers being configured to grip the material coil, and a plurality of grip drive units provided corresponding to the plurality of feeding grippers, the plurality of grip drive units being configured to press the plurality of feeding grippers so that the plurality of feeding grippers surrounds at least a portion of the outer periphery of the material coil.

Alternatively, in the coil feeding apparatus for manufacture of a hairpin according to the embodiment of the present disclosure, the feeding plate may include a feeding motor configured to move the feeding plate by a predetermined distance in a predetermined direction along the base rail.

In the coil feeding apparatus for manufacture of a hairpin according to the embodiment of the present disclosure, the guide module may include a reference bar disposed adjacent to the fixed module and fixed to one end of the guide rail and a plurality of variable bars disposed between the reference bar and the feeding module so as to linearly reciprocate along the guide rail, and the reference bar and the plurality of variable bars may guide the material coil so that the material coil is fed in a straightened state along a straight path between the feeding module and the fixed module.

Alternatively, in the coil feeding apparatus for manufacture of a hairpin according to the embodiment of the present disclosure, the feeding plate may linearly reciprocate between a first point at which a distance from the reference bar is minimum and a second point at which the distance from the reference bar is maximum.

In the coil feeding apparatus for manufacture of a hairpin according to the embodiment of the present disclosure, the guide module may include a deployment unit having an end connected to the reference bar and another end connected to the feeding plate, the deployment unit being configured to expand to increase in length or contract to decrease in length in accordance with change in position of the feeding plate with respect to the reference bar.

Alternatively, in the coil feeding apparatus for manufacture of a hairpin according to the embodiment of the present disclosure, in the guide module, the plurality of variable bars may be coupled to the deployment unit in the state of being disposed at predetermined intervals, and may move away from or close to each other with the same interval therebetween in accordance with change in length of the deployment unit.

The coil feeding apparatus for manufacture of a hairpin according to the embodiment of the present disclosure may include an image sensor mounted between the guide module and the fixed module and configured to sense the presence or absence of a predetermined mark from the material coil and to transmit information about the presence or absence of the mark to a controller.

A vehicle may include the motor having the hairpin manufactured using the coil feeding apparatus.

An electric vehicle may include the motor having the hairpin manufactured using the coil feeding apparatus.

### BRIEF DESCRIPTION OF THE DRAWINGS

The above and other objects, features, and other advantages of the present disclosure will be more clearly understood from the following detailed description taken in conjunction with the accompanying drawings, in which:

FIG. 1 is a view for explaining a hairpin of a motor;

FIG. 2 is a perspective view for explaining a material coil wound on a winding bobbin;

FIG. 3 is a flowchart for explaining a process of manufacturing a hairpin of a motor;

FIG. 4 is a hairpin manufacturing process diagram schematically showing the entire process of manufacturing a hairpin of a motor;

FIG. 5 is a perspective view schematically showing a coil feeding apparatus according to an embodiment of the present disclosure;

FIGS. 6 and 7 are operational state views schematically showing a process in which a material coil is fed by the coil feeding apparatus according to the embodiment of the present disclosure; and

FIG. 8 is a schematic view for explaining a coupling relationship between a feeding module and a guide module in the coil feeding apparatus according to the embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings.

In the following description of the embodiments disclosed in the present specification, a detailed description of known functions and configurations incorporated herein will be omitted when the same may make the subject matter of the embodiments disclosed in the present specification rather unclear.

In addition, the accompanying drawings are provided only for a better understanding of the embodiments disclosed in the present specification and are not intended to limit the technical ideas disclosed in the present specification.

It will be understood that when a component is referred to as being “connected to” or “coupled to” another component, it may be directly connected to or coupled to the other component, or intervening components may be present.

The first direction X, the second direction Y, and the third direction Z described herein refer to respective dimensions and directions of a three-dimensional coordinate system for describing a three-dimensional shape. Thus, the first direction X, the second direction Y, and the third direction Z may be indicated by arrows intersecting each other perpendicularly at one point in space.

The present disclosure relates to an apparatus 64 for feeding a material coil 50 for manufacture of a hairpin 10.

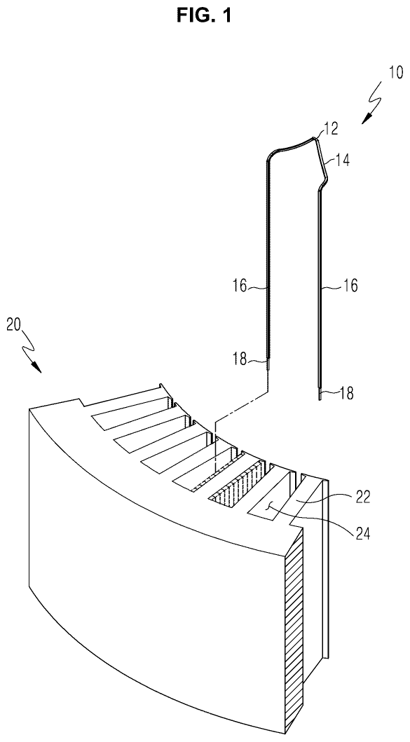

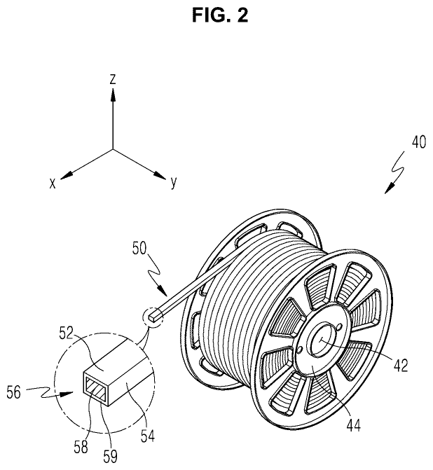

FIG. 1 is a view for explaining a hairpin of a motor, and FIG. 2 is a perspective view for explaining a material coil wound on a winding bobbin.

Referring to FIGS. 1 and 2, an electric motor includes a stator 20 and a rotor.

Generally, the stator 20 corresponds to a fixed part of the motor. A material coil 50 may be wound on a stator core 22 in a predetermined direction.

As shown in the drawings, the material coil 50 may be processed in the shape of a hairpin 10, and may be coupled to the stator core 22. The stator core 22 may be provided in plural, and the plurality of stator cores 22 may be disposed at regular intervals. Each of stator slots 24 is formed between adjacent ones of the stator cores 22.

The material coil 50 may be cut to a predetermined length (feed pitch), and the cut material coil may be transformed into a hairpin 10. The hairpin 10 may be mounted in each of the stator slots 24.

When current is applied to the hairpins 10 densely coupled to the stator 20, a magnetic field is formed around the stator 20. Then, the rotor rotates relative to the stator 20 under the influence of the magnetic field formed around the stator 20.

The apparatus 64 for feeding the material coil 50 according to the embodiment of the present disclosure may be utilized in a process of manufacturing the hairpin 10.

The hairpin 10 is manufactured by processing the material coil 50 cut to a predetermined length (hereinafter referred to as a “feed pitch”). Alternatively, in some embodiments of the present disclosure, a bending, stripping, or notching process may be performed in advance on some portions of the material coil 50, and the process of cutting the material coil 50 in units of feed pitch may be performed after the processing and stripping processes.

The material coil 50 is a linear conductive wire having a rectangular cross-section.

In detail, the material coil 50 includes a conductive core 58 made of a conductive material and an insulating film 59 coated on the surface of the conductive core 58. The conductive core 58 may be a linear copper member having a rectangular cross-section, and the insulating film 59 may be an insulative material, such as enamel, coated on the surface of the conductive core 58 to a predetermined thickness.

The hairpin 10 is manufactured by cutting the linear material coil 50 to a predetermined length, and a pair of conductive terminals 18 is formed at respective ends of the hairpin 10. The pair of conductive terminals 18 is formed at respective ends of the hairpin 10 so as to have a predetermined length.

The conductive terminals 18 correspond to portions of the material coil 50 from which the insulating film 59 is removed so that portions of the conductive core 58 are exposed to the outside, thereby serving as terminals for electrical connection.

The hairpin 10 may be divided into a pin head 12, pin shoulders 14, pin arms 16, and the aforementioned conductive terminals 18.

The pin head 12 is a center portion of the hairpin 10, and corresponds to a vertex portion bent at a predetermined angle.

The pin head 12 is a point at which the pair of pin shoulders 14 meets each other. The pair of pin shoulders 14 is linear portions extending bilaterally from the pin head 12.

Based on the state in which the sharp bent portion of the pin head 12 is directed upward as shown in FIG. 1, the pair of pin shoulders 14 may correspond to two sides of a virtual triangle that form a contained angle therebetween, with the vertex of the angle being the pin head 12, in the plan view and the front view.

The pin arms 16 extend downward from the ends of the respective pin shoulders 14. The pin arms 16 form linear portions extending straight in an upward-downward direction, and the conductive terminals 18 are formed at the lower ends of the respective pin arms 16. Further, the two pin arms 16 may be disposed parallel to each other.

The material coil 50 used for manufacture of the hairpin 10 is a linear member having a rectangular cross-section, and may be stored and transported in the state of being wound on a winding bobbin 40.

The winding bobbin 40 may include a bobbin core 44 having a cylindrical shape, shielding plates mounted on respective ends of the bobbin core 44, and a center hole 42 as a through-hole formed through the center of the bobbin core 44 in the longitudinal direction of the bobbin core 44.

The material coil 50 having a rectangular cross-section includes a long side portion 52 having a relatively long length and a short side portion 54 having a relatively short length.

The pair of pin shoulders 14 is portions extending straight bilaterally from the pin head 12, and the pair of pin arms 16 is linear portions bent and extending downward from the ends of the respective pin shoulders 14.

The material coil 50 cut in units of feed pitch has the pair of conductive terminals 18 formed at respective ends thereof. A linear wire portion interconnecting the pair of conductive terminals 18 undergoes a bending process so as to have a predetermined three-dimensional shape, so one hairpin 10 composed of the pin head 12, the pin shoulders 14, and the pin arms 16 may be manufactured.

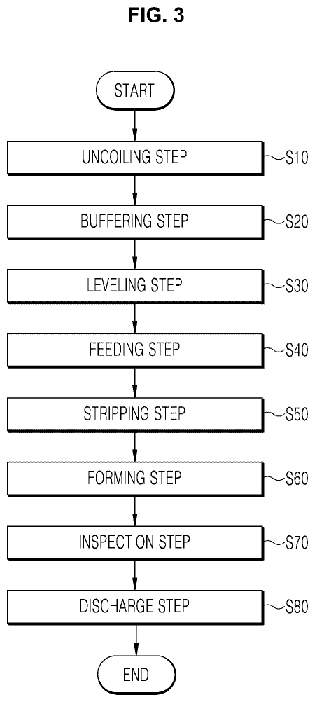

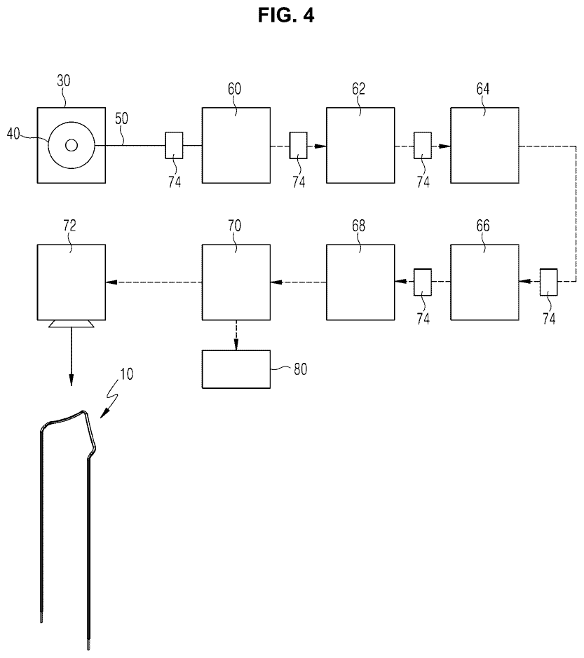

FIG. 3 is a flowchart for explaining a process of manufacturing a hairpin of a motor, and FIG. 4 is a hairpin manufacturing process diagram schematically showing the entire process of manufacturing a hairpin of a motor.

As shown in FIGS. 3 and 4, the process of manufacturing the hairpin 10 may include an uncoiling step S10, a buffering step S20, a leveling step S30, a feeding step S40, a stripping step S50, a forming step S60, an inspection step S70, and a discharge step S80.

The uncoiling step S10 is a step of unwinding the material coil 50 having a rectangular cross-section from the winding bobbin 40 using an uncoiling apparatus 30 and feeding the unwound material coil 50 straight from one end of the winding bobbin 40.

The buffering step S20 is a step of storing the material coil 50 unwound from the winding bobbin 40 and fed straight so that the material coil 50 is fed without delay by unit length for manufacture of the hairpin 10. That is, the buffering step S20 is a step of sufficiently securing the length of the unwound material coil 50, which is capable of being fed, to a predetermined length or longer using a buffering apparatus 60.

The leveling step S30 is a step of straightening the material coil 50 unwound from the winding bobbin 40 using a leveling apparatus 62.

The feeding step S40 may be performed through the feeding apparatus 64. The feeding apparatus 64 holds the material coil 50 and feeds the material coil 50 by a predetermined unit length in a predetermined direction.

The stripping step S50 is a step of removing the insulating film 59, such as enamel, coated on the surface of the material coil 50. The stripping step S50 may be performed through a stripping apparatus 66, and may further include a notching process for the conductive terminals 18 that are formed through removal of the insulating film 59.

The forming step S60 is a step of cutting the material coil 50 to the length for manufacture of each hairpin 10, i.e., the feed pitch, and bending the material coil 50 cut to the feed pitch using a forming apparatus 68, thereby forming the pin head 12, the pin shoulders 14, and the pin arms 16.

The inspection step S70 is a step of inspecting the hairpin 10 having undergone the forming step S60 using an inspection apparatus 70 to determine whether the hairpin 10 is a non-defective product or a defective product.

The discharge step S80 is a step of feeding the hairpin 10 determined to be a non-defective product in the inspection step S70 to a discharge apparatus 72. The hairpin 10 determined to be a non-defective product may be moved along the discharge apparatus 72 and may be loaded at a predetermined position.

Feeding guides 74 may be provided between the apparatuses for performing the above-described respective processes in order to correct the direction and position of the material coil 50 that is fed between the apparatuses.

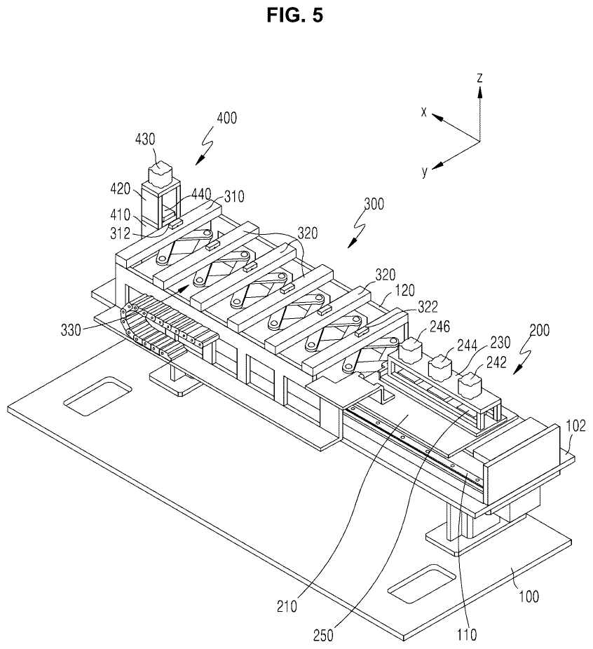

FIG. 5 is a perspective view schematically showing a coil feeding apparatus according to an embodiment of the present disclosure.

As shown in FIG. 5, the coil feeding apparatus according to the embodiment of the present disclosure includes a base plate 102, a feeding module 200, a fixed module 400, and a guide module 300.

The base plate 102 is formed as a firm foundation structure.

The upper surface of the base plate 102 may be formed to be flat, and a base rail 110 and a guide rail 120 may be mounted on the flat upper surface of the base plate 102.

Each of the base rail 110 and the guide rail 120 may be composed of two feeding rails disposed parallel to each other. The base rail 110 and the guide rail 120 may be connected to each other to form a single straight path.

The feeding module 200 includes a plurality of feeding grippers 250 configured to grip the outer periphery of the material coil, and is coupled to the base rail 110 and/or the guide rail 120 so as to reciprocate along a predetermined path.

The fixed module 400 includes a fixed gripper 440 configured to grip the outer periphery of the material coil while pressing the same. Further, the fixed module 400 is disposed downstream of the feeding module 200 based on the path along which the material coil is fed, and is spaced a predetermined distance from the feeding module 200.

The guide module 300 is mounted between the feeding module 200 and the fixed module 400. The guide module 300 guides the material coil so that the material coil is fed in a straightened state without being bent or twisted.

In more detail, the feeding module 200 includes a feeding plate 210, a grip box 230, a feeding gripper 250, and a grip drive unit 240.

The feeding plate 210 is coupled to the base rail 110 and/or the guide rail 120 provided on the base plate 102 so as to be movable along the straight path formed by the base rail 110 and/or the guide rail 120.

The grip box 230 is provided on the feeding plate 210. The grip box 230 defines a space through which the material coil passes so as to be fed in the longitudinal direction thereof. That is, the material coil passes through the space defined in the grip box 230 in the longitudinal direction thereof.

The feeding gripper 250 is provided in plural and is disposed in the grip box 230. The feeding gripper 250 may be made of a highly elastic material, and may be disposed adjacent to the straight path along which the material coil is fed.

In the embodiment of the present disclosure, the feeding gripper 250 may be implemented in the form of two pads facing each other with the material coil interposed therebetween.

A gap between the two pads may be adjusted in accordance with operation of the grip drive unit 240. Accordingly, the two pads may grip the outer periphery of the material coil fed therebetween while pressing the same.

As shown in the drawings, a plurality of feeding grippers 250 may be disposed in a row. The operation of each of the feeding grippers 250 may be controlled by a respective one of a first grip drive unit 242, a second grip drive unit 244, and a third grip drive unit 246, which are controlled separately from each other.

The feeding plate 210 may be further provided with a feeding motor 220. The feeding motor 220 moves the feeding plate 210 by a predetermined distance in a predetermined direction along the base rail 110 and/or the guide rail 120.

The guide module 300 is mounted between the feeding module 200 and the fixed module 400. The guide module 300 supports the load of the material coil in order to prevent a portion of the material coil fed between the feeding module 200 and the fixed module 400 from sagging.

In addition, the guide module 300 prevents occurrence of undesirable stress in the material coil fed between the feeding module 200 and the fixed module 400. That is, the guide module 300 guides the material coil so that a portion of the material coil is fed in a straightened state in a straight direction without being twisted or bent.

The guide module 300 includes a reference bar 310, a variable bar 320, and a deployment unit 330.

In the embodiment of the present disclosure, the reference bar 310 and the variable bar 320 may be implemented as plate-shaped members having a rectangular upper surface. In addition, the reference bar 310 and the variable bar 320 may be made of a material that is highly rigid and is hardly deformed by external force or change in temperature.

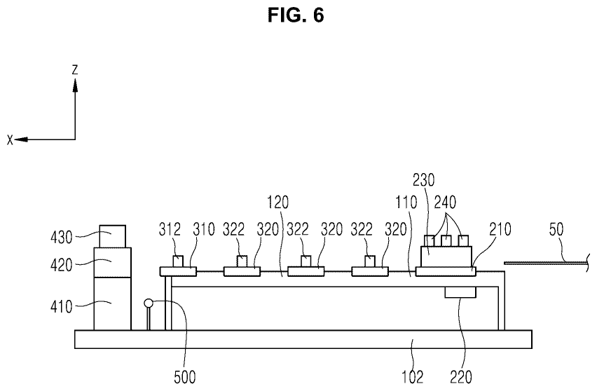

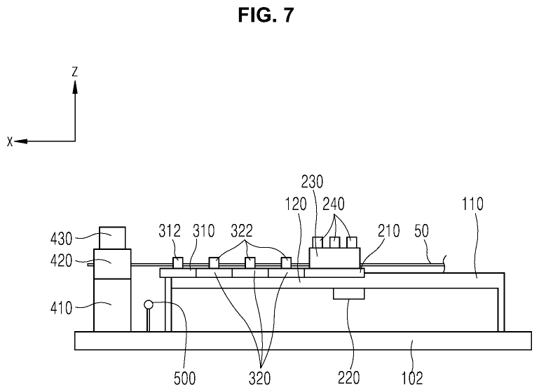

FIGS. 6 and 7 are operational state views schematically showing a process in which the material coil is fed by the coil feeding apparatus according to the embodiment of the present disclosure.

As shown in FIGS. 6 and 7, the base rail 110 and the guide rail 120 form a straight path having a predetermined length on the base plate 102.

The feeding module 200 and the guide module 300 are coupled to the base rail 110 and/or the guide rail 120.

The guide rail 120 has an end connected to the base rail 110 while facing the feeding module 200. The other end of the guide rail 120 is located at a position opposite the feeding module 200.

The fixed module 400 is provided at a position adjacent to the other end of the guide rail 120.

The reference bar 310 is fixed to the other end of the guide rail 120. The reference bar 310 is fixed to the other end of the guide rail 120 so that a relatively wide and flat surface thereof faces upward.

A plurality of variable bars 320 may be disposed parallel to the reference bar 310 between the other end of the guide rail 120 to which the reference bar 310 is fixed and the feeding module 200.

The variable bars 320 may slide along the movement path formed by the base rail 110 and the guide rail 120. The sliding direction of the variable bars 320 may be set such that the variable bars 320 move away from the reference bar 310 toward the feeding module 200 or approach the reference bar 310 at the same height as the reference bar 310.

That is, the variable bars 320 may slide in the X-axis direction shown in FIGS. 6 and 7.

The deployment unit 330 may be coupled to the feeding module 200, the reference bar 310, and the variable bars 320. In the embodiment of the present disclosure, the deployment unit 330 may be coupled to lower portions of the reference bar 310 and the variable bars 320.

One end of the deployment unit 330 is coupled to the feeding module 200, and the other end of the deployment unit 330 is coupled to the reference bar 310.

As the feeding module 200 slides in the +X-axis directions relative to the reference bar 310, the deployment unit 330 is deformed such that the length between one end thereof and the other end thereof coupled to the feeding module 200 and the reference bar 310, respectively, increases or decreases.

The variable bars 320 are coupled to an upper side of the deployment unit 330 while being disposed at regular intervals. As the distance between the reference bar 310 and the feeding module 200 increases, the plurality of variable bars 320 disposed between the reference bar 310 and the feeding module 200 moves away from each other with identically increasing intervals therebetween along with expansion of the deployment unit 330.

On the contrary, as the distance between the reference bar 310 and the feeding module 200 decreases, the plurality of variable bars 320 disposed between the reference bar 310 and the feeding module 200 moves close to each other with identically decreasing intervals therebetween along with contraction of the deployment unit 330.

In the embodiment of the present disclosure, when a position of the feeding module 200 at which the distance between the reference bar 310 and the feeding module 200 is minimum is defined as a first point and a position of the feeding module 200 at which the distance between the reference bar 310 and the feeding module 200 is maximum is defined as a second point, the feeding module 200 moves between the first point and the second point on the base rail 110 and/or the guide rail 120 in accordance with operation of the feeding motor 220.

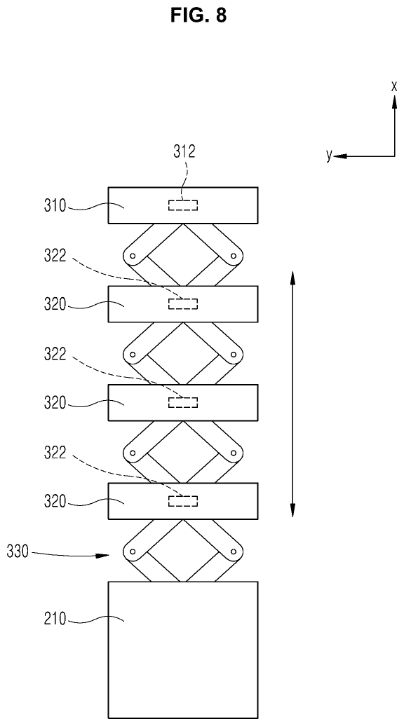

FIG. 8 is a schematic view for explaining a coupling relationship between the feeding module 200 and the guide module 300 in the coil feeding apparatus according to the embodiment of the present disclosure.

As shown in FIG. 8, the deployment unit 330 may be implemented in a form in which a plurality of pairs of linear members, each of the pairs of which is rotatably hinged at centers thereof to each other, is disposed in a row and is hinged at ends thereof to another pair of linear members adjacent thereto. Accordingly, even when the feeding module 200 moves in one direction on the base rail 110 in accordance with operation of the feeding motor 220 provided at the feeding module 200, the variable bars 320 disposed between the feeding module 200 and the reference bar 310 may be disposed in an evenly distributed manner with regular intervals therebetween in the space between the feeding module 200 and the reference bar 310.

The reference bar 310 may be provided on an upper surface thereof with a reference guide 312, and the variable bars 320 may be provided on upper surfaces thereof with variable guides 322. The reference guide 312 and the variable guides 322 guide the feeding path of the material coil so that the material coil is fed in the longitudinal direction thereof.

A reference feeding path 314 is formed in the reference guide 312 as a passage through which the material coil is capable of passing. A variable feeding path 324 is formed in each of the variable guides 322 as a passage through which the material coil is capable of passing.

The fixed module 400 includes a fixed frame 410, a fixed box 420, a fixed drive unit 430, and a fixed gripper 440.

The fixed module 400 is provided at a position adjacent to the other end of the guide rail 120.

The fixed frame 410 is formed as a structure that is coupled to the upper surface of the base frame 100 and extends upward from the base frame 100 to a predetermined height.

The fixed box 420 is provided on the upper end of the fixed frame 410. Further, the fixed box 420 is disposed on the feeding path of the material coil to form a passage through which the material coil is capable of passing.

The fixed gripper 440 may be provided in the fixed box 420. Similarly to the feeding gripper 250, the fixed gripper 440 may be made of a highly elastic material, and may be implemented in the form of two pads facing each other with the material coil interposed therebetween.

A gap between the two pads of the fixed gripper 440 facing each other may be adjusted in accordance with operation of the fixed drive unit 430. Accordingly, the two pads of the fixed gripper 440 may selectively grip the outer periphery of the material coil while pressing the same.

In addition, an image sensor 500 may be provided in the space between the guide module 300 and the fixed module 400.

The image sensor 500 functions to inspect the external appearance of the material coil that enters the fixed box 420 of the fixed module 400 after passing through the upper side of the guide module 300.

The image sensor 500 observes the external appearance of the material coil passing through a predetermined area and transmits data on the external appearance of the material coil to a controller. The controller determines, based on the data on the external appearance of the material coil transmitted from the image sensor 500, a damaged portion of the insulating film of the material coil, a crack in the insulating film, and a deformed portion of the material coil, thereby determining whether the material coil is defective.

As is apparent from the above description, according to the present disclosure, a material coil may be fed in units of feed pitch required for manufacture of a hairpin. Thus, the material coil may be supplied by one feed pitch to each of processing apparatuses, so it is possible to prevent congestion of material coils, which may occur between different processing apparatuses.

According to the present disclosure, even in the case in which a material coil of a unit feed pitch is long and heavy in order to manufacture a large hairpin, it is possible to evenly support the material coil that is fed, thereby preventing a portion of the material coil from sagging or being deformed.

According to the present disclosure, it is possible to easily adjust a speed at which a material coil is fed and a length by which the material coil is fed per unit time, thereby improving productivity.

The effects achievable through the disclosure are not limited to the above-mentioned effects, and other effects not mentioned herein will be clearly understood by those skilled in the art from the above description.

The embodiments of the present disclosure have been described above with reference to the accompanying drawings. However, the embodiments are only proposed for illustrative purposes, and the present disclosure is not limited to the above-described embodiments and the accompanying drawings.

It will be apparent to those skilled in the art that various changes in form and details may be made without departing from the scope and spirit of the disclosure. It is to be understood that the embodiments described herein are part of the present disclosure.

The embodiments described herein should not be construed as limiting the scope of the present disclosure. The scope of the present disclosure should be defined by the technical spirit set forth in the appended claims.

In addition, although not all actions or effects according to the configuration of the embodiments have been explicitly described, it is apparent that actions or effects predictable from the configuration should also be recognized as falling within the spirit and scope of the present disclosure.

What is claimed is:

1. A coil feeding apparatus configured to feed a material coil to manufacture a hairpin for a motor, the coil feeding apparatus comprising:
a base plate provided on an upper surface with a base rail and a guide rail, the base rail and the guide rail being connected to each other to form a straight path;
a feeding module configured to grip an outer periphery of the material coil;
a fixed module along a feeding path of the material coil, the fixed module being configured to grip the material coil; and
a guide module disposed between the feeding module and the fixed module, configured to guide the material coil.

2. The coil feeding apparatus according to claim 1, wherein the feeding module is configured to reciprocate along the base rail.

3. The coil feeding apparatus according to claim 1, wherein the fixed module is positioned downstream of the feeding module.

4. The coil feeding apparatus according to claim 1, wherein the feeding module comprises:
a feeding plate coupled to the base rail to move along the base rail;
a grip box provided on the feeding plate, defining a space therein to allow the material coil to pass through in a longitudinal direction;
a plurality of feeding grippers provided within the grip box, each feeding gripper configured to grip the material coil; and
a plurality of grip drive units corresponding to the feeding grippers, each grip drive unit configured to press the respective feeding gripper so that it surrounds at least a portion of the outer periphery of the material coil.

5. The coil feeding apparatus according to claim 4, wherein the feeding plate comprises a feeding motor configured to move the feeding plate a predetermined distance in a predetermined direction along the base rail.

6. The coil feeding apparatus according to claim 5, wherein the guide module comprises:
a reference bar disposed adjacent to the fixed module and fixed to one end of the guide rail; and
a plurality of variable bars disposed between the reference bar and the feeding module, configured to reciprocate along the guide rail;
wherein the reference bar and the variable bars guide the material coil in a straightened state along a straight path between the feeding module and the fixed module.

7. The coil feeding apparatus according to claim 6, wherein the feeding plate reciprocates linearly between a first point where the distance from the reference bar is minimized and a second point where the distance from the reference bar is maximized.

8. The coil feeding apparatus according to claim 7, wherein the guide module comprises a deployment unit having one end connected to the reference bar and another end connected to the feeding plate, the deployment unit being configured to expand or contract in length according to the position of the feeding plate relative to the reference bar.

9. The coil feeding apparatus according to claim 8, wherein the variable bars in the guide module are coupled to the deployment unit at predetermined intervals, moving away from or closer to each other while maintaining the same interval as the deployment unit changes in length.

10. The coil feeding apparatus according to claim 1, further comprising:
an image sensor positioned between the guide module and the fixed module, configured to observe an external appearance of the material coil passing through a predetermined area; and
a controller configured to determine, based on the external appearance information of the material coil from the image sensor, whether the material coil is defective.

11. The coil feeding apparatus according to claim 1, wherein the coil feeding apparatus is configured to feed the material coil by a predetermined length in a predetermined direction.

12. The coil feeding apparatus according to claim 1, wherein the coil feeding apparatus is configured to manufacture the hairpin for the motor of an electric vehicle.

13. A vehicle comprising the motor having the hairpin manufactured using the coil feeding apparatus of claim 1.

14. An electric vehicle comprising the motor having the hairpin manufactured using the coil feeding apparatus of claim 1.
